(19) United States
(12) Patent Application Publication
(10) Pub. No.: US 2011/0257921 A1
(43) Pub. Date: Oct. 20, 2011

(54) METHOD FOR DETERMINING THE PRESSURE OFFSET OF AN IN-CYLINDER PRESSURE SENSOR

(75) Inventors: Claudio MONFERRATO, Rondissone (TO) (IT); Alessandro CATANESE, Orbassano (TO) (IT)

(73) Assignee: GM GLOBAL TECHNOLOGY OPERATIONS LLC, Detroit, MI (US)

(21) Appl. No.: 13/086,855

(22) Filed: Apr. 14, 2011

(30) Foreign Application Priority Data
Jan. 22, 2010 (GB) 1001028.8

(51) Int. Cl. G01L 27/00; G06F 19/00

(52) U.S. Cl. 702/98

(57) ABSTRACT

An embodiment of the invention provides a method for determining the pressure offset of an in-cylinder pressure sensor of an internal combustion engine, comprising the steps of: setting a plurality of couples of instants during an engine cycle within the cylinder; acquiring the pressure measured by the in-cylinder pressure sensor in each instant of each couple of instants; calculating a plurality of pressure offset values, each of which as a function of the pressures measured in a correspondent couple of instants (θiA, θiB); setting an admissible pressure offset range; selecting the pressure offset values that fall within the admissible pressure offset range; and, if the number of selected pressure offset values is greater than a minimum allowable limit, calculating a final pressure offset as a function of the selected pressure offset values.

### CROSS-REFERENCE TO RELATED APPLICATION

This relates to British Patent Application No. 1001028.8, filed Jan. 22, 2010, which is incorporated herein by reference in its entirety.

### TECHNICAL FIELD

The technical field relates to a method for determining the pressure offset of an in-cylinder pressure sensor of an internal combustion engine, typically of a Diesel engine.

### BACKGROUND

Recent Diesel engine control systems are designed for adjusting the fuel injection in each cylinder through a closed loop control of at least a characteristic combustion parameter, such as the 50% fuel mass fraction burned (MFB50) or the indicated mean effective pressure (IMEP), whose computation requires to directly measure the pressure within the cylinder itself, also referred as in-cylinder pressure, during each engine cycle. In order to measure the in-cylinder pressure, these Diesel engine control systems are generally provided with a pressure sensor that is located directly into the cylinder, typically integrated in a glow plug, for generating an electrical signal in response of the internal pressure.

The signal delivered by the in-cylinder pressure sensors is however usually reduced by a gap, defined as the lower limit of the signal that can be delivered by the sensor, so that the actual in-cylinder pressure is not directly related to the signal delivered but to the sum of the signal and the gap. As a matter of fact, the gap results in a pressure offset that deviates the in-cylinder pressure measured by the sensor from the actual in-cylinder pressure.

One of the drawbacks of these sensors is that the above mentioned gap generally varies depending on a plurality of engine operating parameters, mainly on engine speed and engine load. It follows that, in order to continuously monitor the actual in-cylinder pressure during the operations of the Diesel engine, the pressure offset of the sensor must be calculated at least once per engine cycle. The pressure offset can be calculated during the compression stroke, before the beginning of the combustion phase, using the known physical equation of polytrophic compression:

P(θ)·V(θ)^{K}=cons tan t (1)

Where P is the actual in-cylinder pressure, V is the volume within the cylinder, θ is the crank angle, and K is the polytrophic index.

The preceding equation can be rewritten as:

[p(θ)+Δp]·V(θ)^{K}=cons tan t (2)

Where p is the in-cylinder pressure measured by the sensor, and Δp is the pressure offset.

Applying the last equation to a pair of different instants A and B, it results that:

[p(θ_{A})+Δp]·V(θ_{A})^{K}=[p(θ_{B})+Δp]·V(θ_{B})^{K} (3)

from which, it is possible to calculate the pressure offset as:

$$Δ p = \frac{{V ( {θ}_{B} )}^{K}}{{V ( {θ}_{A} )}^{K} - {V ( {θ}_{B} )}^{K}} \cdot p ( {θ}_{B} ) - \frac{{V ( {θ}_{A} )}^{K}}{{V ( {θ}_{A} )}^{K} - {V ( {θ}_{B} )}^{K}} \cdot p ( {θ}_{A} ) \qquad ( 4 )$$

Nevertheless, it has been found that the electrical signal delivered by the in-cylinder pressure sensor is generally affected by many noises, caused for example to the glow plug current, which can generate fake pressure spikes in the pressure curve sensed by in-cylinder pressure sensor itself. These fake pressure spikes can in turn cause errors in the pressure offset calculation.

A wrong pressure offset calculation compromises the computation of the MFB50, as well as the computation of any characteristic combustion parameters having a strong correlation with the in-cylinder pressure, to thereby reducing the reliability of the whole engine control system.

In view of the foregoing, at least one object is to provide a method for a robust calculation of the pressure offset of an in-cylinder pressure sensor. At least another object is to provide an offset calculation less affected by the fake spikes that can be present on the pressure curve sensed by the sensor. At least a further object is to achieve the above mentioned goals by means of a simple, rational and quite cheap solution. Furthermore, other objects, desirable features and characteristics will become apparent from the subsequent detailed description, and the appended claims, taken in conjunction with the accompanying drawings and this background.

### SUMMARY

An embodiment provides a method for determining the pressure offset of an in-cylinder pressure sensor of an internal combustion engine, comprising the steps of setting a plurality of couples of instants during an engine cycle within the cylinder, acquiring the pressure measured by the in-cylinder pressure sensor in each instant of each couple of instant calculating a plurality of pressure offset values, each of which as a function of the pressures measured in a correspondent couple of instants, setting an admissible pressure offset range, selecting the pressure offset values that fall within the admissible pressure offset range, and if the number of selected pressure offset values is greater than a minimum allowable limit, calculating a final pressure offset as a function of the selected pressure offset values.

As a matter of fact, trough the setting of the admissible pressure offset range and the selection of the pressure offset values that fall within this range, the method disregards the pressure offset values that are probably affected by fake pressure spikes, to thereby providing a reliable final pressure offset.

According to an embodiment, the final pressure offset is calculated as a mean of the selected pressure offset values. In this way, the calculation of the final pressure offset is quite simple and quick.

According to another embodiment, if the number of selected pressure offset values is not greater than the minimum allowable limit, the final pressure offset is assumed to be equal to a final pressure offset determined during a previous implementation of the method. As a matter of fact, when the number of selected offset values is not greater than the minimum allowable limit, it means that the most of the calculated pressure offset values are affected by fake pressure spikes, so that a reliable final pressure offset cannot be calculated at the present stage. Therefore, by assuming that the pressure offset is equal to that of the previous stage, it is effectively possible to reduce the measuring error.

According to a further embodiment, the minimum allowable limit for the number of selected pressure offset values is calculated as a percentage of the total number of calculated pressure offset values. In this way, the calculation of the minimum allowable limit is quite simple and quick.

According to another embodiment, each instant of each couple of instants is set within a compression stroke of the engine cycle, typically before the beginning of the combustion phase into the cylinder. In this way, each pressure offset values can be advantageously calculated using the equation (4) reported in the preamble.

According to a further embodiment, the setting of the plurality of couples of instants comprises the steps of setting a plurality of sampling windows within the engine cycle, said sampling windows being increasing in width and contained into each other, and assuming the extreme points of each sampling window as a couple of instants. In this way, the setting of the couples of instants is quite simple and quick.

According to an embodiment, the smaller sampling window of said plurality has a predetermined width.

As a matter of fact, said width identifies the minimum distance between two instants of a single couple, and can be advantageously determined so as to reasonably avoid that both instants fall in a fake pressure spike, whereby they could generate a completely unreliable pressure offset value.

According to another embodiment, the setting of the admissible pressure offset range comprises the steps of: quantizing the pressure magnitude in a plurality of contiguous and not overlapping pressure regions equal in size, determining the pressure region in which the major number of pressure offset values falls, and assuming at least said determined pressure region as admissible pressure offset range. This strategy has the advantage of setting an admissible range that very probably contains only pressure offset values not affected by errors due to fake pressure spikes.

According to a further embodiment, the setting of the admissible pressure offset range comprises the step of including, within the admissible pressure offset range, also the two pressure regions that are adjacent to the previously determined pressure region. This aspect has the advantage of widening the admissible pressure offset range; to thereby reducing the negative impact of errors eventually occurred in the quantization of the pressure magnitude.

According to another embodiment, the pressure magnitude is quantized so that one of said pressure regions is centered on a final pressure offset determined during a previous implementation of the method. This aspect has the advantage of improving the quantization of the pressure magnitude, since it is very probable that the new final pressure offset is in the neighborhood of the previous one.

The method can be realized in the form of a computer program comprising a program-code to carry out all the steps of the method and in the form of a computer program product comprising means for executing the computer program.

The computer program product comprises, according to a preferred embodiment, a control apparatus for an IC engine, for example the ECU of the engine, in which the program is stored so that the control apparatus defines the invention in the same way as the method. In this case, when the control apparatus execute the computer program all the steps of the method according to the invention are carried out.

The method can be also realized in the form of an electromagnetic signal, said signal being modulated to carry a sequence of data bits which represent a computer program to carry out all steps of the method.

### BRIEF DESCRIPTION OF THE DRAWINGS

The present invention will now be described, by way of example, with reference to the accompanying drawings, in which:

FIG. 1 is a flowchart of a method according to an embodiment;

FIG. 2 represent the in-cylinder pressure curve during an engine cycle;

FIG. 3 is a magnified detail of FIG. 1; and

FIG. 4 is a graph that represents the quantization of the pressure magnitude according to an aspect of an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

An embodiment provides a method for determining the pressure offset of an in-cylinder pressure sensor 10 associated to a cylinder 20 of a four stroke Diesel engine. The method is implemented once per engine cycle during the operating of the Diesel engine.

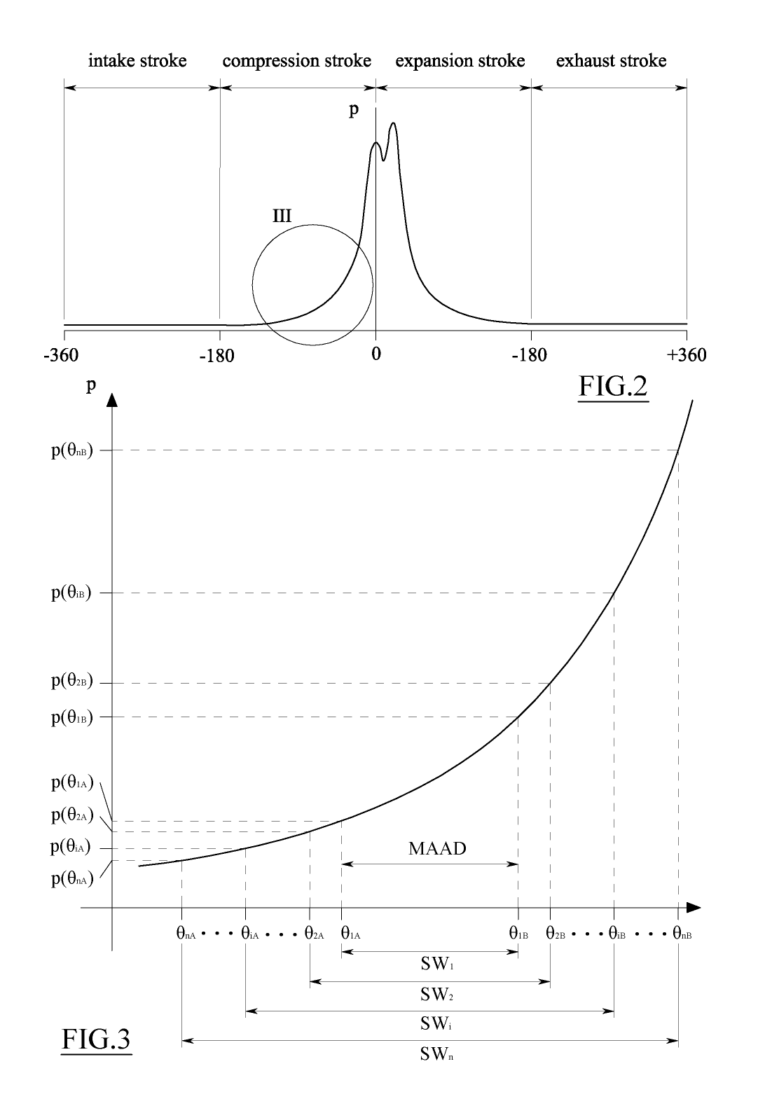

In the four stroke Diesel engine, an engine cycle occurs every 720° of rotation of the crankshaft 30, while the piston 40 performs in sequence an intake stroke, a compression stroke, an expansion stroke and an exhaust stroke. During an engine cycle, the theoretical pressure curve within the cylinder has the characteristic shape illustrated in the graph of FIG. 2, wherein the axis of abscissas identifies the crankshaft angular position and the axis of ordinates identifies the pressure magnitude.

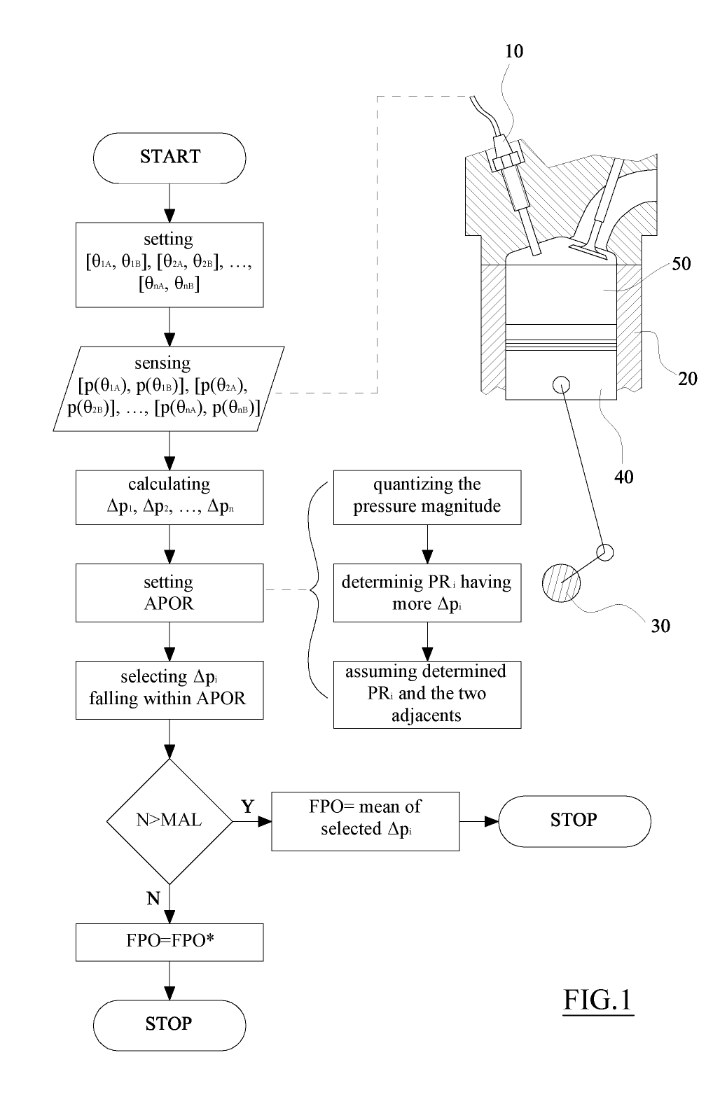

The method for determining the pressure offset of the in-cylinder pressure sensor 10 comprises the main steps that are illustrated in FIG. 1. The first step provides for setting a plurality of couples of instants during the engine cycle, respectively indicated as [θ1A, θ1B], [θ2A, θ2B], . . . , [θnA, θnB]. The instants are individually defined in term of crank-shaft angular position.

As shown in FIG. 2 and FIG. 3, all the instants θ1A, θ1B, θ2A, θ2B, . . . , θnA, θnB, are separated from each other and are located in the compression stroke, before the beginning of the combustion phase within the cylinder 20. The setting of the first couple of instants [θ1A, θ1B] provides for setting a first sampling window SW1 within the compression stroke, and for assuming the extreme points of said first sampling window SW1 as the instants θ1A and θ1B. The width of the first sampling window SW1 is predetermined as the minimum allowable angular distance MAAD between two instants of a single couple.

The setting of the second couple of instants [θ2A, θ2B] provides for setting a second sampling window SW2 within the compression stroke, which is greater in width and which completely contains the first sampling window SW1, and for assuming the extreme points of said second sampling window SW2 as the instants θ2A and θ2B. In this way, the distance between the instants θ2A and θ2B is necessarily greater than the minimum allowable angular distance MAAD.

The setting of each subsequent couple of instants [θiA, θiB] provides for setting a sampling window SWi within the compression stroke, which is greater in width and which completely contains all the previous sampling windows, and for assuming the extreme points of said sampling window SWi as the instants θiA and θiB. As a matter of fact, the setting of the plurality of couples of instants [θ1A, θ1B], [θ2A, θ2B], . . . , [θnA, θnB] generally provides for setting a plurality of sampling windows within the combustion stroke, which are increasing in width and individually contained into each other, and for assuming the extreme points of each sampling window as a couple of instants.

The method further comprises the step of acquiring the pressure measured by the in-cylinder pressure sensor 10 in each instant θij of each couple, in order to obtain a plurality of couples of pressure values that are respectively indicated as [p(θ1A), p(θ1B)], [p(θ2A), p(θ2B)], . . . , [p(θnA), p(θnB)]. Each couple of pressure values [p(θiA), p(θiB)] is then used for calculating a respective pressure offset value Api according to the equation (4) explained in the preamble:

$$Δ {p}_{i} = \frac{{V ( {θ}_{iB} )}^{K}}{{V ( {θ}_{iA} )}^{K} - {V ( {θ}_{iB} )}^{K}} \cdot p ( {θ}_{iB} ) - \frac{{V ( {θ}_{iA} )}^{K}}{{V ( {θ}_{iA} )}^{K} - {V ( {θ}_{iB} )}^{K}} \cdot p ( {θ}_{iA} ) \qquad ( 5 )$$

Where V(θij) is the volume of the combustion chamber 50 defined by the cylinder 20 and the piston 40 in the correspondent instant θij, and K is the polytrophic index. Each volume value V(θij) can be determined through simple geometrical relations. As a matter of fact, the method provides for calculating a plurality of pressure offset values Δp1, Δp2, . . . , Δpn, each of which is determined as a function of the pressure values measured in a respective couple of instants, respectively [p(θ1A), p(θ1B)], [p(θ2A), p(θ2B)], . . . , [p(θnA), p(θnB)].

Moreover, the method comprises the step of setting an admissible pressure offset range APOR, in which it is expected to find the actual value of pressure offset, also referred as final pressure offset FPO in the present description. The setting of the admissible pressure offset range APOR is performed through a subroutine.

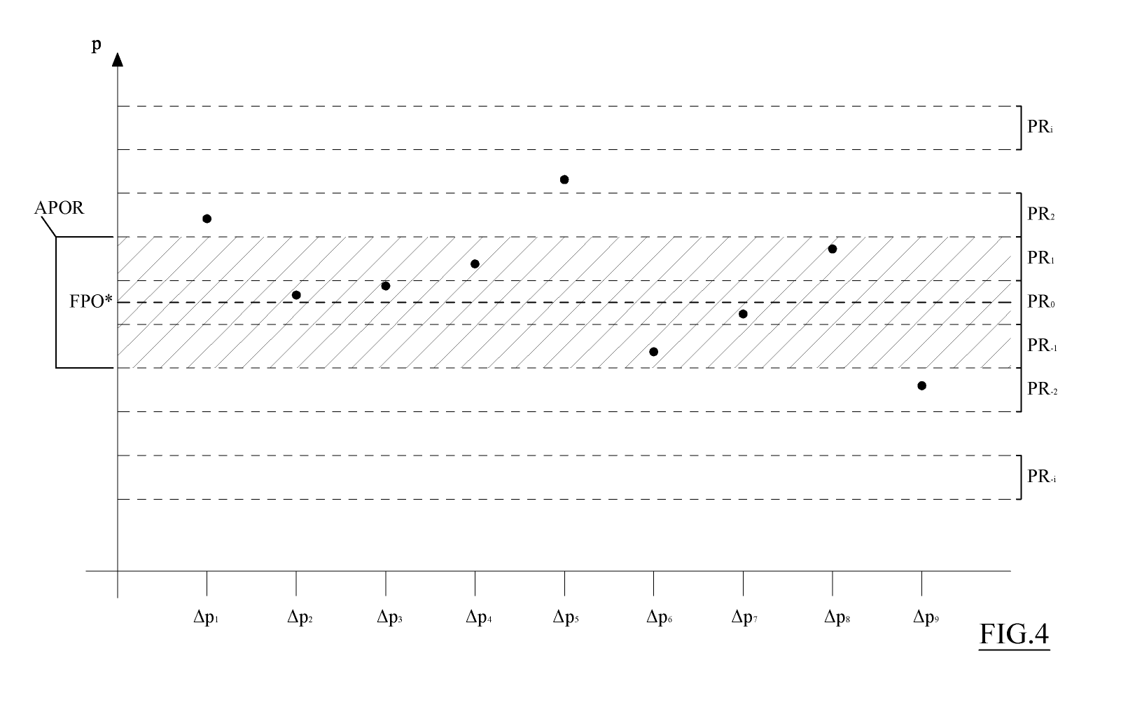

The subroutine provides for quantizing the pressure magnitude in a plurality of contiguous and not overlapping pressure regions, which are indicated as PR-i, . . . , PR-2, PR-1, PR0, PR1, PR2, . . . PRi in the graph of FIG. 4. The pressure regions PR-i, . . . , PR-2, PR-1, PR0, PR1, PR2, . . . PRi have the same size, to thereby quantizing the pressure magnitude in levels having the same distance from each other.

The pressure region PR0 is centered on the final pressure offset FPO* that has been determined during the previous implementation of the method, that is during the compression stroke of the previous engine cycle. After the pressure magnitude has been quantized, the subroutine provides for determining the pressure region in which falls the major number of pressure offset values Δpi that has been previously calculated. Finally, the subroutine provides for assuming said determined region as admissible pressure range APOR, together with the previous and the next regions, that is the two regions immediately adjacent to the determined one.

In the example of FIG. 4, the major number of pressure offset values Api falls in the pressure region PR0, so that the admissible pressure range APOR is formed by the pressure regions indicated as PR-1, PR0 and PR1. At this point, the method comprises the step of selecting the pressure offset values Api that fall within the admissible offset range APOR, disregarding the others.

If the number of selected pressure offset values Δpi is greater than a minimum allowable limit MAL, the method finally provides for calculating the final pressure offset FPO as the mean of the selected pressure offset values only. The minimum allowable limit MAL can be expressed as a percentage of the total number of calculated pressure offset values Δpi.

Referring to the example of FIG. 4, nine pressure offset values Δpi has been calculated, of which only six pressure offset values fall within the admissible pressure offset region APOR, more precisely Δp2, Δp3, Δp4, Δp6, Δp7 and Δp8. Assuming for example that MAL corresponds to the 60% of the total number of calculated pressure offset values, it means that the number of selected pressure offset values is greater than the MAL, so that the FPO is calculated as:

$$F P O = \frac{Δ {p}_{2} + Δ {p}_{3} + Δ {p}_{4} + Δ {p}_{6} + Δ {p}_{7} + Δ {p}_{8}}{6} \qquad ( 6 )$$

Conversely, if the number of selected pressure offset values is not greater than the minimum allowable limit MAL, the final pressure offset FPO is assumed to be equal to a final pressure offset FPO* that has been determined during a previous implementation of the method, that is during the previous engine cycle.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the forgoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and in their legal equivalents.

What is claimed is:

1. A method for determining a pressure offset of an in-cylinder pressure sensor of an internal combustion engine, comprising:
setting a plurality of instants pairs during an engine cycle within a cylinder;
acquiring a pressure measured by the in-cylinder pressure sensor in each instant of each instants pairs;
calculating a plurality of pressure offset values, each of the plurality of pressure offset values a function of pressures measured in a correspondent couple of instants;
setting an admissible pressure offset range;
selecting the pressure offset values that fall within the admissible pressure offset range; and
calculating a final pressure offset as a function of the pressure offset values if a number of selected pressure offset values is greater than a minimum allowable limit.

2. The method according to claim 1, wherein the calculating the final pressure offset comprises calculating as a mean of the pressure offset values.

3. The method according to claim 1, further comprising assuming the final pressure offset to be equal to the final pressure offset determined during a previous implementation if a number of selected offset values is not greater than the minimum allow-able limit.

4. The method according to claim 1, wherein the minimum allowable limit for the number of selected pressure offset values is calculated as a percentage of a total number of calculated pressure offset values.

5. The method according to claim 1, wherein each instant of each couple of instants is set within a compression stroke of the engine cycle.

6. The method according to claim 1, wherein the setting of the plurality of instants pairs comprises:
setting a plurality of sampling windows within the engine cycle, said sampling plurality of sampling windows being increasing in width and contained into each other; and
assuming extreme points of each sampling window as a couple of instants.

7. The method according to claim 1, wherein a smaller sampling window of the plurality has a predetermined width.

8. The method according to claim 1, wherein the setting of the admissible pressure offset range comprises:
quantizing a pressure magnitude in a plurality of contiguous and not overlapping pressure regions equal in size;
determining a pressure region in which a major number of pressure offset values falls; and
assuming at least said pressure region as the admissible pressure offset range.

9. The method according to claim 1, wherein the setting of the admissible pressure offset range comprises including, within an admissible offset range, also two pressure regions that are adjacent to a previously determined pressure region.

10. The method according to claim 8, further comprising quantizing the pressure magnitude so that one of said pressure regions is centered on the final pressure offset determined during a previous implementation.

11. A computer readable medium embodying a computer program product, said computer program product comprising:
a program for determining a pressure offset of an in-cylinder pressure sensor of an internal combustion engine, the program configured to:
set a plurality of instants pairs during an engine cycle within a cylinder;
acquire a pressure measured by the in-cylinder pressure sensor in each instant of each instants pairs;
calculate a plurality of pressure offset values, each of the plurality of pressure offset values a function of pressures measured in a correspondent couple of instants;
set an admissible pressure offset range;
select the pressure offset values that fall within the admissible pressure offset range; and
calculate a final pressure offset as a function of the pressure offset values if a number of pressure offset values is greater than a minimum allowable limit.

12. The computer readable medium embodying the computer program product according to claim 11, wherein the program is configured to calculate the final pressure offset with a calculation of a mean of the pressure offset values.

13. The computer readable medium embodying the computer program product according to claim 11, the program further configured to assume the final pressure offset to be equal to the final pressure offset determined during a previous implementation if a number of selected offset values is not greater than the minimum allowable limit.

14. The computer readable medium embodying the computer program product according to claim 11, wherein the minimum allowable limit for the number of selected pressure offset values is calculated as a percentage of a total number of calculated pressure offset values.

15. The computer readable medium embodying the computer program product according to claim 11, wherein each instant of each couple of instants is set within a compression stroke of the engine cycle.

16. The computer readable medium embodying the computer program product according to claim 11, wherein the program is configured to set the plurality of instants pairs comprises by:
setting a plurality of sampling windows within the engine cycle, said sampling plurality of sampling windows being increasing in width and contained into each other; and
assuming extreme points of each sampling window as a couple of instants.

17. The computer readable medium embodying the computer program product according to claim 11, wherein a smaller sampling window of the plurality has a predetermined width.

18. The computer readable medium embodying the computer program product according to claim 11, wherein the program is further configured to set of the admissible pressure offset range by:
quantizing a pressure magnitude in a plurality of contiguous and not overlapping pressure regions equal in size;
determining a pressure region in which a major number of pressure offset values falls; and
assuming at least said pressure region as the admissible pressure offset range.

19. The computer readable medium embodying the computer program product according to claim 18, wherein the program is configured to set the admissible pressure offset range that includes, within an admissible offset range, also two pressure regions that are adjacent to a previously determined pressure region.

20. The computer readable medium embodying the computer program product according to claim 18, the program further configured to quantize the pressure magnitude so that one of said pressure regions is centered on the final pressure offset determined during a previous implementation.
